(19) United States
(12) Patent Application Publication
(10) Pub. No.: US 2024/0246012 A1
(43) Pub. Date: Jul. 25, 2024

(54) FILTRATION MEDIA WITH THERMALLY SPLITTABLE BICOMPONENT FIBERS

(71) Applicant: DelStar Technologies, Inc., Alpharetta, GA (US)

(72) Inventors: Yasar Kiyak, Middletown, DE (US); Andrew G. Platt, Middletown, DE (US); Andrew Scarff, Alpharetta, GA (US)

(21) Appl. No.: 18/418,647

(22) Filed: Jan. 22, 2024

Related U.S. Application Data
(60) Provisional application No. 63/440,517, filed on Jan. 23, 2023.

(51) Int. Cl. B01D 39/16; D01F 8/06; D01F 8/14

(52) U.S. Cl. CPC B01D 39/1623; D01F 8/06; D01F 8/14; B01D 2239/0216; D10B 2321/022; D10B 2505/04

(57) ABSTRACT

Filter media, methods of manufacturing and filters are disclosed. The filter media comprises thermally splittable fibers to reduce the fiber size of at least some components of the fibers within the filter media. This reduced fiber size increases the overall efficiency of such filters at capturing contaminants, particularly those contaminants having a size range of about 0.1 to about 10 microns, without compromising other important characteristics of the filters. A filter media comprises one or more bicomponent fibers each having first and second components. The first component comprises a thermoplastic elastomer material and a thermoplastic material and has a higher shrinkage ratio/percentage/rate than the second component such that at least a portion of the first component separates from the second component upon the application of heat or thermal energy to the fiber.

### TECHNICAL FIELD

This description generally relates to filtration media with improved performance characteristics and more particularly to filter media that incorporate thermally splittable bicomponent fibers.

### BACKGROUND

Liquid and gas filters trap contaminants of many different types from the air, water, or others. Air filters, for example, typically include a filtration media comprising fibrous or porous materials which remove solid particulates, such as dust, pollen, mold, and bacteria from the air.

Two main types of air filtration devices include surface filters and depth filters. Surface filters, such as membranes or films, act as a barrier for contaminants that are captured before they enter the media structure. These surface filters typically have a submicron pore size and narrow pore size distribution. Surface filters tend to have relatively high particle capturing efficiency. However, they also have a relatively high pressure drop and a low dust loading capacity. The high pressure drop results in reduced air flow through the filter. The low dust loading capacity significantly reduces the longevity of the filter. As such, surface filters have been used in a limited number of applications in the air filtration industry.

Depth filters are commonly employed in air filtration devices with a moderate to high efficiency, a low pressure drop, and a relatively high dust loading capacity. Depth filters generally employ various kinds of fibers that may be formed into a web or other nonwoven structure having tortuous paths between the fibers through which a gas stream, such as air, is passed. The particulate matter in the gas flowing through the paths in the web is retained on the upstream side of the web, or within the tortuous paths of the web due to the size of the particles relative to the paths' diameters.

Conventional residential and commercial air filters, such as HVAC filters, are typically rated by the filter's ability to capture particles between about 0.3 and 10 microns. This rating, referred to as a Minimum Efficiency Reporting Value or MERV is developed by the American Society of Heating, Refrigerating and Air Conditioning Engineers (ASHRAE). The MERV ratings range from 1-16, with higher values indicating higher efficiencies at trapping specific types of particles. It is also common to compare efficiency values depending on particle sizes within the air stream during testing. E3, E2, and E1 values refer to particulate efficiency at 3-10 microns, 1-3 microns and 0.3 to 1 microns, respectively.

Contaminants have a wide range of sizes. However, contaminants smaller than 1 micron are the most harmful particles for the human body and are relatively difficult to filter. For example, conventional mechanical air filters typically report MERV ratings for fibrous filtration materials of about 8-10. These filter media typically have fiber sizes that are not small enough to capture submicron particles, such as viruses and other harmful pathogens. Moreover, during the current Covid-19 pandemic, ASHRAE has started to officially recommend that certain high efficiency air filters have ratings of MERV 13 for effective protection against airborne infection. Thus, methods for improving the capture of submicron particles in filter media have become essential.

Current techniques for manufacturing fibers designed for use in filters are limited to producing a minimum size of about 1.7 dtex to about 5.6 dtex (e.g., via carding). Due to the difficulty in producing fibers below a certain size, the filtration industry has focused on two different methods for improving the capture of these submicron particles: electrostatic forces and the utilization of nanoparticles within the filter media.

Electrostatic filters are formed by electrostatically charging the fibers within the fibrous material, using triboelectric methods, corona discharge, hydro charging, electrostatic fiber spinning or other known methods. Electrostatic or “electret” filter media have increased efficiency without necessarily increasing the amount of force required to push the air through the filter media. The “pressure drop” of media is the decrease in pressure from the upstream side of the media to the downstream side. The more difficult it is to force air through the media, the greater the pressure drop, and the greater use of energy to force air through the media. Therefore, it is generally advantageous to decrease pressure drop or maintain pressure drop while increasing the filter's ability to capture contaminants.

Electrostatic filters are most effective at capturing submicron particles, reasonably effective at capturing particles size between 1 and 3 micron, and minimally effective at capturing larger particles from 3 to 10 micron. Electrostatic fibers are commonly used in many filtration applications such as face masks and high efficiency filters to filter submicron contaminants, such as viruses and others.

One drawback with electrostatic filters, however, is that the electrostatic charge decays over time and with use of the filter. Thus, the efficiency of the filter decreases relatively quickly, reducing its longevity. For example, an electrostatic filter having an initial MERV rating of 13 may lose at least 2-3 points of MERV rating after the electrostatic forces have decayed. This compromises the integrity of the filter and may partially or completely inhibit its ability to capture submicron particles. Another drawback with certain electrostatically charged filters is that the materials presently used for these filters are limited in the amount of charge (or charge density) that can be produced on the fibers. The lower the electrostatic charge in the filter, the greater penetration of contaminants. This limitation reduces the overall efficiency of the filter in capturing these contaminants.

Another method for capturing submicron contaminants is the use of nanoparticles in conjunction with the fibers. Filtration systems may employ filter media including relatively large fibers having a diameter measured in micrometers and comparatively smaller nanoparticles. The nanoparticles increase the surface area within the media for capturing particles by reducing the overall fiber size within the media. The nanoparticles also tend to collapse on each other, increasing the packing density within the filter media. It has been shown that even a small amount of nanometer sized fibers formed in a layer on a microfiber material can improve the filtration characteristics of the material.

While existing filter media that incorporate nanoparticles have improved the relative efficiency of these filters, the commercial potential for these filters has been limited in certain applications because the nanoparticles are typically dispersed onto the surface of the fibrous material. This relatively thin layer of nanoparticles on the surface of the filter provides only limited filtering of particles and has a relatively low dust holding capacity.

While filters incorporating electrostatic forces and/or nanoparticles within the filter media have shown promise, there is room for improvement. What is needed, therefore, are improved filtration media for liquid and/or gas filters. It would be particularly desirable to improve the efficiency of such filters at capturing contaminants having a size range of about 0.1 to 1 microns (i.e., E1 particles), without compromising other important characteristics of the filters, such as the overall cost of the filter, or its longevity, dust holding capacity, or the pressure drop or air flow through the filter.

### SUMMARY

The following presents a simplified summary of the claimed subject matter in order to provide a basic understanding of some aspects of the claimed subject matter. This summary is not an extensive overview of the claimed subject matter. It is intended to neither identify critical elements of the claimed subject matter nor delineate the scope of the claimed subject matter. Its sole purpose is to present some concepts of the claimed subject matter in a simplified form as a prelude to the more detailed description that is presented later.

Filtration media and filters are provided that include bicomponent fibers that are thermally splittable to reduce the fiber size of at least some components of the fibers within the filter media. This reduced fiber size increases the overall efficiency of such filters at capturing contaminants without compromising other important characteristics of the filters. Systems and methods of manufacturing such filtration media and filters are also provided.

In one aspect, a filter media comprises one or more bicomponent fibers each having first and second components. The first component comprises a thermoplastic elastomer material and a thermoplastic material and has a higher shrinkage percentage ratio than the second component such that at least a portion of the first component separates from the second component upon the application of heat or thermal energy to the fiber.

In embodiments, the first component after splitting has a size of less than about 1.5 dtex, or about 0.005 to about 0.05 dtex, or about 0.01 to about 0.02 dtex. The term dtex as used herein means the mass in grams for every 10,000 meters of fiber. The first component may have a maximum dimension of about 1-10 microns, or about 3-5 microns. The reduced size of the first component that separates from the bicomponent fiber provides a smaller filament or fiber within the filter media that would otherwise be difficult (if not impossible) to process with current techniques. For example, any staple fiber less than 1.5 Denier cannot currently be run through a conventional carding process without significant issues. Splitting in depth of the structure increases the efficiency of the filter media, particularly at capturing contaminants having a size range of about 0.1 to 1 microns (i.e., E1 particles) and 1 to 3 microns (i.e., E2 particles).

In embodiments, the melting point of the first component is about 100° C. to about 200° C. and smaller than the melting point of the second component, which may be greater than about 200° C. The melt flow rate (MFR) of the first component and the second component are preferably about 10-50 g/10 min.

In embodiments, the thermoplastic elastomer material of the first component is less than about 25% by weight of the first component, or about 10% to about 20% by weight of the first component, preferably about 15%. Applicant has discovered that reducing the overall amount of the thermoplastic elastomer material in the first component reduces the stickiness of the materials in the component, which allows the first component to separate from the second component during heating.

Suitable thermoplastic elastomer materials for the first component include a styrene block copolymer (SBS, SIS, SEBS), an olefin block polymer, a thermoplastic polyolefin elastomer (TPO), a thermoplastic polystyrene elastomer (TPS), a polyester copolymer elastomers such as Hytrel® (a plasticizer-free thermoplastic polyester elastomer produced by Dupont Corporation), a thermoplastic vulcanizate (TPV), a polyamide elastomer (PEBAX), a thermoplastic polyurethane (TPU), an ionomer, an ethylene vinyl acetate (EVA), a propylene-based elastomer, a propylene-ethylene copolymer, an ethylene octane copolymer and combinations thereof. In a preferred embodiment, the thermoplastic elastomer material comprises an olefin block copolymer.

Suitable thermoplastic materials for the first component include polyolefins, polyethylene (PE), polypropylene (PP), blends of PP and PE, PBT, PET, CoPET, PLA, PHB, Polyamide and combinations thereof. In a preferred embodiment, the thermoplastic material in the first component comprises a PP resin and the thermoplastic material in the second component comprises CoPET, PET, PBT, PLA, and Polyamide.

The bicomponent fiber may comprise any suitable shape, such as core/sheath with a concentric core, core/sheath with an eccentric core, side by side with a solid or a hollow core, side by side with a concentric or an eccentric hollow core, segmented pie with a solid or a hollow core, striped fibers, conductive fibers, island by the sea, mixed fibers, or combinations thereof. In certain embodiments, the bicomponent fiber comprises a segmented pie with about 4 to about 32 segments, preferably between about 8 to about 20 segments. In an exemplary embodiment, the core of the segmented pie is hollow and is substantially concentric.

The second component may comprise any suitable material having a higher melting point than the first component. Suitable materials for the second component include, but are not limited to, polyolefins, polyethylene (PE), polypropylene (PP), blends of PP and PE, PBT, PET, PLA, PA and combinations thereof.

The ratio of weight between the first and second components may be about 20/80 to about 80/20. In certain embodiments, the second component has a greater weight percentage than the first component. In an exemplary embodiment, the first component has a weight percentage of about 50% of the bicomponent fiber, or about 40% or about 30% or about 20%.

The bicomponent fiber may comprise staple fibers or continuous fibers. The fibers may be naked (i.e., zero spin finish) prior to filter media making process. The fibers may include a spin finish prior to the filter media making process.

In an exemplary embodiment, the bicomponent fiber is a staple fiber having a conventional spin finish of less than about 2% and a length of about 40 to about 80 mm, or about 60 mm. Applicant has discovered that applying a spin finish coating to the fibers decreases the stickiness of the elastomer in the first component. In certain embodiments, the thermoplastic material and the thermoplastic elastomer material are selected to have similar or substantially the same melt viscosities to improve fiber spinning.

In embodiments, the bicomponent fiber is crimped prior to separation of the first and second components. Applicant has discovered that crimping the fibers improves separation and thus the overall efficiency of the filter media. In an exemplary embodiment, the fibers are crimped from about 6 crimp/inches to about 30 crimps/inch, preferably about 10 to about 20 crimps/inch.

In embodiments, the first and second components are heated to a temperature of about 60 degrees C. to about 200 degrees C., preferably about 110 degrees C. to about 160 degrees C. Applicant has discovered that this temperature ranges provides sufficient shrinkage of the first component to achieve separation between the first and second components, while minimizing the stickiness of the elastomer in the first component.

In embodiments, the filter media further comprises one or more second fibers that are not thermally splittable or are thermally splittable at higher temperatures than the first bicomponent fibers, i.e., the second fibers comprise a single material or a plurality of materials with substantially the same melting point, MFR and/or shrinkage ratio/percentage. Suitable materials for the second fibers are including but not limited to HDPE/PET, PP/PET, HDPE/PP, PLA/PLA, PP/PLA, and CoPET/PET bicomponent fibers and PE, PP, PET, PLA, Polyamide monocomponent fibers.

The second fibers improve the bonding and increase the “loft” of the filter media. The loft as used herein is defined as the volume of void space compared to the volume of the total solid. The ratio of the first and second fibers in the filter media may be about 80/20 to about 20/80. In certain embodiments, the second fibers comprise about 40% to about 60%, or about 50%, by weight of the filter media.

In embodiments, the second fibers comprise a biocomponent fiber such as core/sheath, core/sheath with an eccentric core, side by side with solid or hollow core, side by side with concentric or eccentric hollow core, segmented pie with solid or hollow core, striped fibers, conductive fibers, island by the sea, mixed fibers, or combinations thereof. In an exemplary embodiment, the second fiber comprises a core/sheath fiber having an eccentric core. Applicant has discovered that including a second fiber with an eccentric core reduces the overall pressure drop across the filter media.

In embodiments, the second fibers have a lower linear mass density than the bicomponent fibers. For example, the splittable bicomponent fibers may have a linear mass density of about 1 denier to about 8 denier, or about 5 to 6 denier, while the second fibers may have a linear mass density of about 1 to about 8 denier or about 3 denier.

In certain embodiments, the fibers in the filter media may be electrostatically charged such that, for example, contaminants are captured both with mechanical and electrostatic filtration. The electrostatic or electret substrate could be, for example, high loft triboelectric filter media made by carding and needling.

In another aspect, a filter is provided comprising a filter media as described above. The filter may further include a substantially rigid support layer bonded to the filter media. The fiber substrate may comprise an extruded film comprising one or more apertures for the flow of or liquid therethrough. For example, the apertures can be hexagonal, circular, square, or diamond shaped.

The filter may include pleats. For example, the fiber substrate may comprise at least one crease to form a pleat within the substrate. In another example, the filter further includes a plurality of pleats extending across a surface of the fiber substrate. The fiber substrate can be non-pleated.

In another aspect, a method of making a filter media comprises providing one or more bicomponent fibers each having first and second components and heating the biocomponent fibers such that at least a portion of the first component separates from the second component. The first component comprises a thermoplastic elastomer material and a thermoplastic material. The thermoplastic elastomer material is less than about 25% by weight of the first component.

In one embodiment, the bicomponent fibers are thermally bonded to each other at a temperature that allows at least a portion of the first component to separate from the second component. The biocomponent fiber is heated to a temperature of about 60 degrees C. to about 200 degrees C., preferably about 110 degrees C. to about 160 degrees C. In embodiments, the first component is shrunk by at least about 10% or at least about 60% during the heating. The specific amount of shrinkage may be controlled by controlling the amount of thermoplastic elastomer in the first component. Increasing the ratio of thermoplastic elastomer material to thermoplastic material in the first component increases the amount of shrinkage of the first component.

In another embodiment, the amount of shrinkage of the first component is controlled via the amount of drawing during fiber spinning. Specifically, increasing the amount of drawing stretches the physical bonds of the elastomer resin so that more shrinkage occurs upon heating.

The fibers of the substrate can be manufactured by any suitable method, including, without limitation, meltblown, bicomponent meltblown, spunbond or spunlace, bicomponent spunbond, heat-bonded, carded, air-through bonded carded, air-laid, wet-laid, extrusion, co-formed, needlepunched, stitched, hydraulically entangled or the like. In certain embodiments, naked continuous fibers are formed through a process selected from the group consisting of spunbond and meltblown. In other embodiments, staple fibers incorporating filter media are formed through carding, air-laid, wet-laid or similar processes.

In one such embodiment, the bicomponent fiber is carded. The method further comprises crimping the bicomponent fiber prior to the carding step. The crimp count of the biocomponent fiber is about 6 to about 30 crimps/inch, preferably about 10 to about 20 crimps/inch.

In embodiments, the method further comprising blending one or more second fibers with the first fibers. The second fibers may be formed of a single component or more than one component that remains substantially bonded to each other during heating. In embodiments, the second fibers comprise bicomponent fibers having at least two components that remains substantially bonded to each other during heating.

In embodiments, the first component and/or the second component comprise slip additives selected to reduce the interface energy between the first and second components. This increases the amount of splitting that occurs between these components during the heating and bonding steps.

The recitation herein of desirable objects which are met by various embodiments of the present description is not meant to imply or suggest that any or all these objects are present as essential features, either individually or collectively, in the most general embodiment of the present description or any of its more specific embodiments.

### BRIEF DESCRIPTION OF THE DRAWINGS

FIG. 1A is a cross-sectional view of a bicomponent fiber for a filter media;

FIG. 1B is an enlarged view of a first component of the bicomponent fiber of FIG. 1A;

FIG. 2 is a cross-sectional view of a bicomponent fiber after fiber spinning;

FIG. 3 is a cross-sectional view of a bicomponent fiber after carding;

FIG. 4 is a cross-sectional view of a bicomponent fiber after thermal bonding;

FIG. 5A is a schematic of a plurality of biocomponent fibers after extrusion;

FIG. 5B is a schematic of the biocomponent fibers after cutting and crimping;

FIG. 5C is a schematic of the biocomponent fibers after carding;

FIG. 5D is a schematic of the biocomponent fibers after thermal bonding;

FIG. 6 is an optical microscope image of a cross-section of biocomponent fibers described herein; and

FIG. 7 represents a series of optical microscope images of fibers described herein during after being carded and bonded.

### DETAILED DESCRIPTION OF THE EMBODIMENTS

This description and the accompanying drawings illustrate exemplary embodiments and should not be taken as limiting, with the claims defining the scope of the present description, including equivalents. Various mechanical, compositional, structural, and operational changes may be made without departing from the scope of this description and the claims, including equivalents. In some instances, well-known structures and techniques have not been shown or described in detail so as not to obscure the description. Like numbers in two or more figures represent the same or similar elements. Furthermore, elements and their associated aspects that are described in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment. Moreover, the depictions herein are for illustrative purposes only and do not necessarily reflect the actual shape, size, or dimensions of the system or illustrated components.

It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

Except as otherwise noted, any quantitative values are approximate whether the word “about” or “approximately” or the like are stated or not. The materials, methods, and examples described herein are illustrative only and not intended to be limiting.

Filter media and filters, such as gas or liquid filters, face masks, CPAP filters, vacuum bags, cabin air filters, HVAC furnace filters, residential air filters, commercial air filters, gas turbine, and compressor air intake filters, panel filters and the like, are provided. The filtration media and filters described herein include bicomponent fibers that are thermally splittable to reduce the fiber size of at least some components of the fibers within the filter media. This reduced fiber size increases the specific surface are thus increases the overall efficiency of such filters at capturing contaminants, particularly those contaminants having a size range of about 0.1 to about 1 microns (i.e., E1 particles), without compromising other important characteristics of the filters, such as pressure drop and air permeability.

The bicomponent fibers each have at least first and second components. In certain embodiments, at least some of the first components are separated from the second component(s) during carding and/or thermal bonding. The separated first component(s) have a substantially smaller size than the bicomponent fiber.

In some embodiments, the bicomponent fiber has a size of about 1.5 to about 18 dtex, or about 1.5 to about 5.6 dtex. The term dtex as used herein means the mass in grams for every 10,000 meters of fiber. The first components may separate or split from the second components to produce substantially smaller fibers or filaments or segments. After separation or splitting, for example, at least some of the first component(s) have a size of less than about 1.5 dtex, or about 0.005 to about 0.05 dtex, or about 0.01 to about 0.02 dtex. The first component may have a maximum dimension of about 1-10 microns, or about 3-5 microns.

The bicomponent fiber may comprise any suitable shape, such as core/sheath with a concentric core, core/sheath with an eccentric core, side by side with a solid or a hollow core, side by side with a concentric or an eccentric hollow core, segmented pie with a solid or a hollow core, striped fibers, conductive fibers, island by the sea, mixed fibers, or combinations thereof.

In an exemplary embodiment, the bicomponent fiber comprises a segmented pie with about 4 to about 32 segments, preferably between about 8 to about 20 segments. In an exemplary embodiment, the core of the segmented pie is hollow and is substantially concentric.

The first component comprises a thermoplastic elastomer material and a thermoplastic material and has a higher shrinkage ratio/percentage/rate than the second component such that at least a portion of the first component separates from the second component upon the application of heat or thermal energy to the fiber.

In embodiments, the melting point of the first component is about 50° C. less than the melting point of the second component. The MFR of the first and second components are preferably similar to each other. In embodiments, the MFR of these components is about 10-50 g/10 min.

In embodiments, the thermoplastic elastomer material of the first component is less than about 25% by weight of the first component, or about 10% to about 20% by weight of the first component, preferably about 15%.

Suitable thermoplastic elastomer materials for the first component include a styrene block copolymer (SBS, SIS, SEBS), an olefin block polymer, a thermoplastic polyolefin elastomer (TPO), a thermoplastic polystyrene elastomer (TPS), a polyester copolymer, polyester elastomer (e.g., Hytrel®), a thermoplastic vulcanizate (TPV), a polyamide elastomer (PEBAX), a thermoplastic polyurethane (TPU), an ionomer, an ethylene vinyl acetate (EVA), a propylene-based elastomer, a propylene-ethylene copolymer, an ethylene octane copolymer and combinations thereof. In a preferred embodiment, the thermoplastic elastomer material comprises an olefin block copolymer, such as Vistamaxx™ 7020BF, manufactured by Exxon (a propylene ethylene copolymer).

In terms of selection of polymer blends, miscible resins are blended with similar materials. For example, PP may be mixed with olefin block copolymer based elastomer, and polyamide elastomer is blended with a polyamide resin, and the polyester elastomer resin is blended with PET or PBT. In other embodiments, any elastomer could be blended any thermoplastic polymer resin as long as they are miscible. For instance, to further increase shrinkage, PLA can be blended with olefin block copolymers.

Suitable thermoplastic materials for the first component include polyolefins, polyethylene (PE), polypropylene (PP), blends of PP and PE, PBT, PET, PLA, PA, CoPET and combinations thereof. In a preferred embodiment, the thermoplastic material comprises PP.

The second component may comprise any suitable material having a higher melting point and/or a similar melt flow rate (MFR) to the first component. Suitable materials for the second component include, but are not limited to, polyolefins, polyethylene (PE), polypropylene (PP), blends of PP and PE, PBT, PET, PLA, polyamides, and combinations thereof.

The ratio of weight between the first and second components may be about 20/80 to about 80/20. In certain embodiments, the second component has a greater weight percentage than the first component. In an exemplary embodiment, the first component has a weight percentage of about 50% of the bicomponent fiber, or about 40% or about 30% or about 20%.

The fibers may be staple fibers or continuous fibers. The fibers may be naked (e.g., zero spin finish) or the fibers may include a spin finish. The spin finish may include but is not limited to, lubricants, emulsifiers, antistats, anti-microbial agents, cohesive agents and wetting agents. Other organic liquids, such as alcohols or blends of organic liquids may be added to the spin finish. The spin finish may be applied, for example, during carding of the fibers, during the melt spinning operation, or operation of drawing, crimping, and cutting of the fibers.

In an exemplary embodiment, the bicomponent fiber is a staple fiber having a conventional spin finish of less than about 2% and a length of about 40 to about 80 mm, or about 60 mm. In certain embodiments, the thermoplastic material and the thermoplastic elastomer material are selected to have substantially the same melt viscosity.

In embodiments, the bicomponent fiber is crimped prior to separation of the first and second components. In an exemplary embodiment, the fibers are crimped from about 8 crimp/inches to about 30 crimps/inch, preferably about 14 to about 20 crimps/inch.

In embodiments, the first and second components are heated to a temperature of about 60 degrees C. to about 200 degrees C., preferably about 110 degrees C. to about 160 degrees C. and more preferably about 130 degrees C. to about 160 degrees C.

In embodiments, the filter media further comprises one or more second fibers that are not thermally splittable, i.e., the second fibers comprise a single material or a plurality of materials with substantially the same melting point, MFR and/or shrinkage ratio/percentage. In other embodiments, the second fibers are thermally splittable at higher temperatures than the first fibers. In these embodiments, the first and second fibers will be thermally bonded at temperatures that allow for thermal splitting of the first fibers without substantial thermal splitting of the second fibers. The second fibers improve the bonding and increase the “loft” of the filter media. The loft as used herein is defined as the volume of void space compared to the volume of the total solid. The ratio of the first and second fibers in the filter media may be about 80/20 to about 20/80. In certain embodiments, the second fibers comprise about 40% to about 60%, or about 50%, by weight of the filter media.

In embodiments, the second fiber comprises a biocomponent fiber such as core/sheath, core/sheath with an eccentric core, side by side with solid or hollow core, side by side with concentric or eccentric hollow core, segmented pie with solid or hollow core, striped fibers, conductive fibers, island by the sea, mixed fibers, or combinations thereof. In an exemplary embodiment, the second fiber comprises a core/sheath fiber having an eccentric core. Applicant has discovered that including a second sheath/core fiber with an eccentric core reduces the overall pressure drop across the filter media.

The fibers may have thicknesses that are suitable for the application. In some embodiments, the fibers have at least one dimension in the range of about 1 to about 10,000 micrometers or about 1 to about 1,000 micrometers or about 10 to 100 micrometers. The thickness of the fibers may also be measured in denier, which is a unit of measure in the linear mass density of fibers. In some embodiments, the fibers may have a linear density of about 1 denier to about 10 denier. The fibers may be configured as a gradient density media in which the pore size decreases from the upper surface of the filter (upstream) to the lower surface (downstream) or vice versa to increase capture efficiency and dust holding capacity.

In certain embodiments, the second fibers have a broad range of linear mass density. For example, the first bicomponent fibers may have a linear mass density of about 1 denier to about 18 denier, or about 3 to 6 denier, while the second fibers may have a linear mass density of about 1 to about 18 denier or about 3 to 6 denier.

In certain embodiments, a filter media may include at least two different fiber thicknesses or linear densities to provide at least two different layers of the filter within the same filter media. In certain embodiments, the filter media may include three or more separate portions or layers with different denier fiber ranges within each portion.

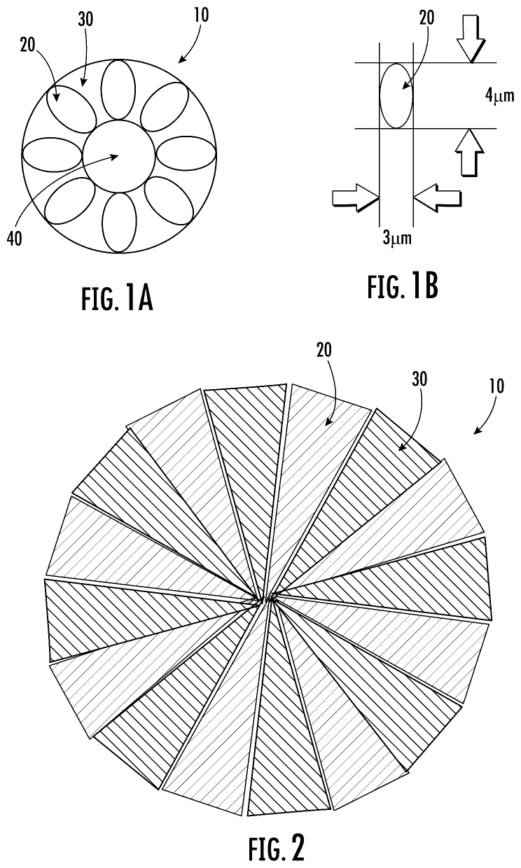

Referring now to FIG. 1, one embodiment of a bicomponent fiber 10 will now be described. As shown, fiber 10 is a segmented pie bicomponent fiber having a first component 20 and a second component 30. Second component 30 is formed as an annular filament surrounding a hollow center portion 40. First component 20 preferably comprises a plurality of filaments extending through the annular second component 30. Fiber 10 is shown as having eight first component filaments which provides 16 segments in the pie, although it will be understood that bicomponent fiber 10 may comprise a segmented pic with about 4 to about 32 segments, preferably between about 8 to about 20 segments.

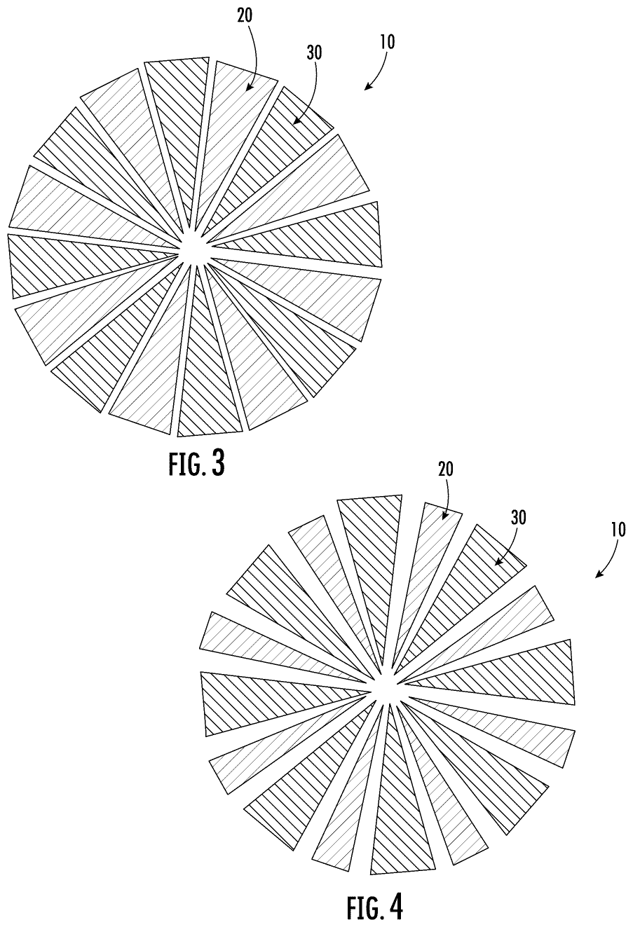

Each filament of first component 20 may have any suitable cross-sectional shape, such as circular, oval, rectangular, square, triangular and the like. In one embodiment, the filaments have substantially pie slice cross-sectional shapes, as shown in FIG. 2. The dimensions for such filaments may include a diameter along the semi-major axis of about 0.1 microns to about 10 microns, or about 3 microns to about 5 microns, preferably about 4 microns. The diameter along the semi-minor axis may be about 1 microns to about 10 microns, or about 2 microns to about 4 microns, preferably about 3 microns. The overall size of the first component filaments is about 0.1 to 1.1 dtex.

In certain embodiments, the bicomponent fibers discussed herein may be included as part of a filter device that traps or absorbs contaminants, such as a liquid filter, a gas filter for home and commercial air filtration (e.g., HVAC), a surgical mask, or other face covering or the like. The filter device may be a mechanical filter, absorption filter, sequestration filter, ion exchange filter, reverse osmosis filter, surface filter, depth filter or the like, and may be designed to remove many different types of contaminants from the air, water, or others.

In one such embodiment, the fibers are incorporated into an air filter that removes particles and contaminants from the air, such as a HEPA filter (i.e., pleated mechanical air filter), a UV light filter, an electrostatic filter, a washable filter, a media filter, a spun glass filter, pleated or unpleated air filters, active carbon filters, pocket filters, V-bank compact filters, filter sheets, flat cell filters, filter cartridges and the like. The media may comprise a such splittable fiber for the air filter and may be supported by a support layer or a scrim layer, or may be included in other layers or materials.

Conventional home and commercial air filters, such as HEPA or pleated filters, are typically rated by the filter's ability to capture particles between about 0.3 and 10 microns. This rating, referred to as a Minimum Efficiency Reporting Value or MERV is developed by the American Society of Heating, Refrigerating and Air Conditioning Engineers (ASHRAE). The MERV ratings range from 1-16, with higher values indicating higher efficiencies at trapping specific types of particles. It is also common to compare efficiency values in depending on particle sizes within the air stream during testing. E3, E2 and E1 values refer to particulate efficiency at 3-10 microns, 1-3 microns, and 0.3 to 1 micron, respectively.

The predicted MERV rating of the filter media discussed herein will vary based on many factors, including the types and sizes of fibers used in the filter media, the width of the filter media, the number and size of pleats (if any), face velocity and the like. Likewise, the pressure drop across the filter media will also depend on many factors, including those mentioned above.

In certain embodiments, the substrate is a filter media for a gas filter, such as an HVAC filter. In these embodiments, the thermally splittable fibers increase the efficiency of a filter media in capturing contaminants in the E1, E2, and E3 particle groups about 5-30 points, or an increase of about 10% to about 50%. In these embodiments, the MERV rating of the filter media may be increased solely through provision of the thermally splittable fibers. The MERV rating may be increased from MERV 6 to MERV 10. The pressure drop across the filters remain substantially the same. Thus, the thermally splittable fibers increased the efficiency of the filter media without compromising pressure drop.

In certain embodiments, the filter media comprises a nonwoven material that includes a substrate, sheet, layer, film, apertured film, mesh or other media comprising fibers. The nonwoven substrate discussed herein may comprise a structure of individual fibers or threads that are interlaid, interlocked, or bonded together. Nonwoven fabrics may include sheets or web structures bonded together by entangling fiber or filaments (and by perforating films) mechanically, thermally, or chemically. They may be substantially flat, porous sheets that are made directly from separate fibers or molten plastic or plastic film. Examples of suitable nonwoven materials include, but are not limited to, fibers, layers or webs that are meltblown, spunbond or spunlace, heat-bonded, bonded carded, air-laid, wet-laid, co-formed, needlepunched, stitched, hydraulically entangled or the like.

In some embodiments, nonwoven textiles may be used in, for example, mesh filter press cloths, nonwoven filter pads and other die cut pieces, centrifuge filter bags, liquid filter bags, dust collector bags, bed dryer bags, rotary drum filters, filter belts, leaf filters, furnace filters, roll media and the like.

The fibers contemplated may have many shapes in cross-section, including without limitation, circular, kidney bean, dog bone, trilobal, barbell, bowtie, star, Y-shaped, and others. These shapes and/or other conventional shapes may be used with the embodiments to obtain the desired performance characteristics. The fibers in the filter media stay connected to each other through thermal bonds and chemical bonds, by being entangled with one another, through the use of binding agents, such as adhesives, or the like.

The bicomponent fibers in the media may stay connected to other fibers, such as the second non-thermally splittable fibers discussed above) by being thermally bonded, chemically bonded, or entangled with one another. In some embodiments, the substrate may comprise a “high loft” nonwoven material comprising spunbond or air through bonded carded nonwoven fibers. In air through bonded carded nonwoven fibers, the loftiness of a substrate can be controlled by various means known to those of skill in the art. For example, loftiness can be increased by applying less compression force onto the media during bonding. In another example, a high loft nonwoven material can be manufactured with fibers having larger thicknesses, such as thicknesses greater than 3 denier, e.g., 5 denier or greater, 6 denier or greater (discussed in more detail below). In other embodiments, the loftiness may be increased by using eccentric biocomponent fibers. In other embodiments, loftiness can be increased by using non-bondable fibers.

In certain embodiments, the fibers may be electrostatically charged such that, for example, contaminants are captured both with mechanical and electrostatic filtration. The substrate can be electrostatically charged using triboelectric methods, corona discharge, electrostatic fiber spinning, hydro charging, charging bars or other known methods. Corona charging is suitable for charging polymeric fiber or fiber blend, or fabrics. Tribocharging may be suitable for charging fibers with dissimilar electronegativity. The electrostatic or electret filter media could be high loft triboelectric filter media made by carding and needling. Electrostatic fiber spinning combines the charging of the polymer and the spinning of the fibers as a one-step process. Suitable methods for triboelectric charging is described in U.S. Pat. No. 9,074,301 and commonly assigned Provisional Patent Application Ser. No. 63/410,729, filed Sep. 28, 2022, the entire disclosures of which are hereby incorporated by reference herein for all purposes.

The filtration media may comprise a charge additive to modify the triboelectric charge of the fibers and increase the stability and/or duration of the triboelectric charge in the filter. This increases the overall filtration efficiency of the filter without compromising other important characteristics of the filters, such as longevity, dust holding capacity, and the pressure drop or air flow through the filter. Suitable charge additives for triboelectric charging are described in commonly assigned Provisional Patent Application Ser. No. 63/410,731, filed Sep. 28, 2022, the entire disclosures of which are hereby incorporated by reference herein for all purposes.

In certain embodiments, the fibers may include a silicone-based coating to improve the efficiency of the filter media at capturing contaminants, particularly contaminants in the E2 and E3 particle group range. The silicone-based coating may comprise a reactive silicone macroemulsion. The silicone emulsion may comprise, for example, dimethyl silicone emulsions, amino type silicone emulsions, organo-functional silicone emulsions, resin type silicone emulsions, film-forming silicone emulsions, or the like. In one embodiment, the reactive silicone macroemulsion comprises an amino functional polydimethylsiloxane and/or a polyethylene glycol monotridecyl ether. Suitable silicone coatings are described in commonly assigned U.S. Provisional Patent Application Ser. No. 63/406,686, filed Sep. 14, 2022, the complete disclosure of which is incorporated herein by reference.

In some embodiments, the filter media may be scored, pleated, or folded into a pleated filter. The pleats may be formed by various conventional pleating operations that include, but are not limited to, bar, rotary, and star gear pleating operations. Filters include one or more support layers bonded to the filter media. In some embodiments, polymer layers, membranes or films are provided that include one or more apertures for flow of gas or liquid therethrough. In other embodiments, the material comprises a flexible surface layer for a finger bandage pad, a face mask or the like.

In certain embodiments, the fibers may be included in, or bonded to, a thin film or layer that includes apertures, pores or perforations. The apertures may be embossed in a pattern (such as circular, diamond-shaped, hexagonal, oblong, triangular, rectangular, etc.) and then stretched until apertures form in the thinned out areas created by the embossing. Such an apertured substrate can be formed from many polymers, such as polypropylene, polyethylene, high density polyethylene (“HDPE”), and the like. The polymer layer may, for example, comprise an extruded film. An apertured film is available commercially and is marketed under the trademark Delnet®. The substrate is provided in a roll and nanofibers are deposited into the substrate in a roll-to-roll process.

The contemplated fibers may be manufactured and/or processed by any method, including, without limitation, the air laid or dry laid methods, carding, spinneret, gel spinning, melt spinning, wet spinning, dry spinning, islands-in-a sea staple or spunbond, segmented pic staple or spunbond, and others. Such methods are described in U.S. Pat. Nos. 4,406,950, 6,338,814, 6,616,435, 6,861,142, 7,252,493, 7,300,272, 7,309,430, 7,422,071, 7,431,869, 7,504,348, 7,774,077 9,522,357, 9,993,761 and US Patent Publication No. 2009/266,759, the completed disclosures of which are hereby incorporated herein by reference for all purposes.

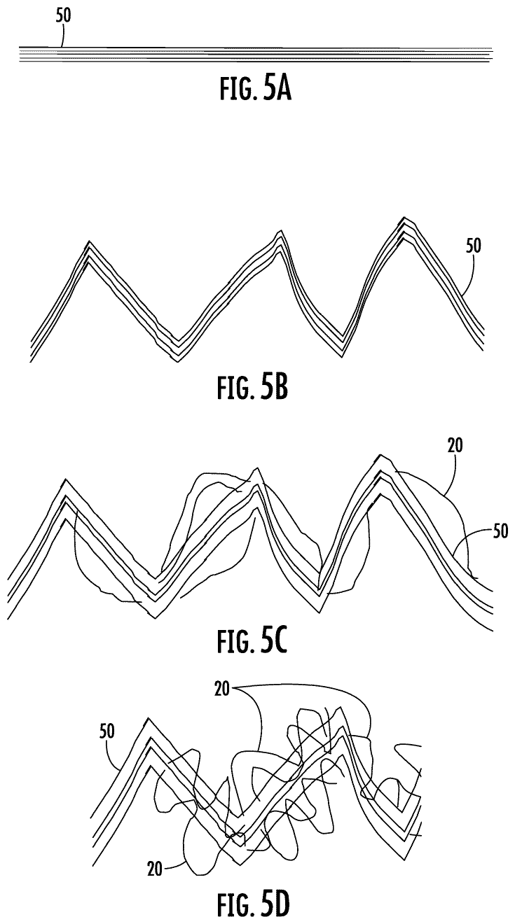

In an exemplary embodiment, the filter media are manufactured by forming a bicomponent fiber with first and second components as described above. The filaments of the fibers are melted and then extruded or drawn through spinneret holes in the extruder to form a bicomponent shape, e.g., segmented pie, side by side, etc. FIG. 2 illustrates a representative bicomponent fiber 10 after fiber spinning, illustrating first and second components 20, 30. FIG. 5A illustrates a plurality of fibers 50 after extrusion.

In an exemplary embodiment, the staple fibers are carded. The system may comprise one carding machine or two carding machines disposed in-series with each other. Short fiber lengths (40-80 mm) are processed through fiber opening, blending, and consolidation into a continuous fibrous web. FIG. 3 illustrates a representative fiber 10 after carding, illustrating slight separation of the first and second components 20, 30. FIG. 5C illustrates a plurality of fibers 50 after carding, showing that some of the first components 20 have started to separate from the fibers 50 to form substantially smaller diameter filaments or fibers.

Once the fibrous web has been formed by carding, a secondary process of bonding may be used to give the fibrous web integrity and strength. This bonding process may be accomplished through chemical, thermal or mechanical methods. In one embodiment, the fibers are thermally bonded with heat, which also results in separation of at least some of the first components from the second components 20, 30 (see FIGS. 4 and 5D).

In an exemplary embodiment, the fibers are heated and bonded in an air through oven machine at temperatures of less than about 200 degrees C., preferably between about 110 to 180 degrees C., or about 150 degrees C. In embodiments, the first component is shrunk by at least about 10% or at least about 40% during the heating.

In certain embodiments, the fibers are coated with a spin finish and crimped before, during or after the melt spinning process. FIG. 5B illustrates a plurality of fibers that have been cut and crimped before the carding process.

In some embodiments, first and/or second component of the thermosplittable fiber comprises slip additives for easy splitting during thermal activation. Slip additives are selected from including but now limited to waxes, low surface energy additives, ceramics, lubricant etc.

In other embodiments, naked continuous fibers are formed through a process selected from the group consisting of spunbond and meltblown. In one example, the system may comprise a spunbond line, wherein filaments are formed by spinning molten polymer and stretching the molten filaments. Fiber bundles of filaments are separated and spread, and then and layered on a net to form a web. The fibers are bound in the form of a sheet through thermal bonding and embossing. Thermosplittable filaments are then splitted during the thermoprocess.

In yet another example, the fibers may be formed with meltblowing dies. Examples of suitable meltblowing dies that may be utilized for manufacturing nonwoven materials are discussed in more detail in U.S. Pat. Nos. 6,972,104, 8,017,534 and 7,772,456 and US Patent Application No. US20200216979A1, the complete disclosures of which are incorporated herein by reference in their entirety for all purposes.

### EXAMPLES

The applicant conducted numerous tests of thermally splittable fibers for filter media. In these tests, Applicant discovered a number of critical features of the fibers and the process for manufacturing the fibers that create significant improvements in the filtration efficiency of filter medias comprising these fibers.

### First Trial

In the first trial, the applicant tested the filtration efficiency of a filter media comprising a bicomponent filament or fiber having a segmented pie cross-section (16 pies) with a hollow center, a mass linear density of 3 Denier and a fiber length of 60 mm. The first component comprised a 75:25 by weight blend of a PP resin and an elastomer material having a tradename of Vistamaxx™ 7020BF, manufactured by Exxon. The second component comprised 100% PET in a first sample and 97% PET and a 3% slip additive in a second sample. The first component comprises 60% of the fiber by volume and the second component comprises 40% by volume. The fibers were cut manually without any crimping.

Applicant then manufactured a filter media comprising two different fibers: (1) a 3 denier bicomponent fiber comprising materials that are not thermally splittable; and (2) the bicomponent fiber described above. The ratio of the two fibers was 80% non-splittable fiber and 20% splittable. Applicant compared testing results of this filter media with a standard filter media comprising 100% non-splittable 3 denier fibers. The summary of the testing results is shown below in TABLE 1.

TABLE 1

| | Thickness | | | | Pressure Drop | | | |
|---|---|---|---|---|---|---|---|---|
| | (mils) | Gsf | Gsm | Osy | (inch H2O) | E1 | E2 | E3 |
| 100% 3D Fiber | 55 | 7.25 | 78 | 2.3 | 0.1470 | −2.0 | 37.7 | 79.8 |
| 80% 3D Fiber + | 53 | 6.60 | 71 | 2.3 | 0.1142 | −1.6 | 30.7 | 77.0 |
| 20% splittable | | | | | | | | |

As shown in Table 1, the splittable fibers reduced the pressure drop but did not substantially improve the filtration efficiency of the filter media as compared to the 100% 3D non-splittable fibers in the E2 and E3 zones. Applicant believes that this occurred because of at least one of five reasons: (1) the bicomponent fibers were not crimped; (2) the percentage by weight of the elastomer in the first component was too high, which caused the elastomer to stick to the second component during drawing; (3) the fibers were heated to a temperature that was too high, also causing the elastomer material to stick to the other splittable fibers; (4) the ratio between the non-thermally splittable fibers and the splittable fibers (i.e., 80/20) was too high; and/or (5) the basis weight of the web with splittable fiber was lower than the control sample.

Applicant also conducted testing of different temperature profiles to determine the optimal temperature for shrinking the splittable fibers. The fibers used for this testing were substantially the same as those described above in the first trial. This testing demonstrated that the first components in the fibers started to shrink significantly around 65-70° C. In addition, the elastomer polymer chips started softening and sticking to each other around 100° C.

Applicant then conducted a second test of the filtration efficiency of a filter media comprising a bicomponent filament or fiber have a hollow segmented pie cross-section (16 pies) with a mass linear density of 3 Denier and a fiber length of 60 mm. The first component comprised a 75:25 by weight blend of a PP resin and an elastomer material having a tradename of Vistamaxx™ 7020BF, manufactured by Exxon. The second component comprised 100% PET in a first sample and 97% PET and a 3% slip additive in a second sample. The first component comprised 60% of the fiber and the second component comprised 40%. The fibers were crimped around 12 crimps/inch. The fibers were heated to a temperature of 150° C. for about 20 seconds.

Applicant then manufactured a filter media comprising two different fibers: (1) a 3 denier bicomponent fiber comprising materials that are not thermally splittable; and (2) the bicomponent fiber described above. The ratio of the two fibers was 70% non-splittable fiber and 30% splittable. Applicant compared testing results of this filter media with a standard filter media comprising 100% non-splittable 3 denier fibers. The summary of the testing results is shown below in TABLE 2.

TABLE 2

| | Pressure Drop | Particle | Particle | Particle | Predicted |
|---|---|---|---|---|---|
| | (inch H2O) | Group | Group | Group | MERV |
| NAME | at 180 FPM | E1 | E2 | E3 | RATING |
| Control: 100% 3D | 0.1598 | 2.9 | 40.0 | 60.4 | 7 |
| Bicomponent | | | | | |
| Sample: 70% 3D | 0.1664 | 3.4 | 46.9 | 82.2 | 9 |
| Bicomponent + | | | | | |
| 30% 3D Splittable | | | | | |

As shown, the 30% splittable sample demonstrated an increase in filtration of the E2 and E3 particle groups. This increased the overall MERV Rating of the filter media from MERV 7 to MERV 9. The pressure drop, however, of the filter media with the sample fibers increased slightly from 0.1598 to 0.1664 in inches H2O at 500 CFM/180 FPM.

Applicant conducted another test of the filtration efficiency of a filter media comprising a bicomponent filament or fiber have a segmented pie cross-section (16 pies) with a hollow center, a mass linear density of 5.6 denier and a fiber length of 60 mm. The first component comprised an 85:15 by weight blend of a PP resin and an elastomer material having a tradename of Vistamaxx™ 7020BF, manufactured by Exxon. The second component comprised 100% PLA. In a first run, the first component comprised 40% of the total fiber cross-section volume and the second component comprises 60%. In a second run, the ratio of first to second component was 50/50. The fibers were crimped around 10-20 crimps/inch. The fibers were heated to a temperature of 150° C. for about 20 seconds.

The applicant determined that using larger bicomponent fibers (i.e., 5.6 denier filaments) reduced the amount of filament breakage during drawing. In addition, the applicant discovered that the lower godet temperature resulted in significantly less filament sticking. In fact, none of the 288 individual filaments that were produced stuck to each other during the manufacturing process.

Applicant then conducted a number of carding trials with the above-described bicomponent fibers to manufacture filter medias. The filter medias comprised two different fibers: (1) a 3 denier bicomponent fiber comprising materials that are not thermally splittable; and (2) the bicomponent fiber described above. In the first carding trial, the 3D fiber comprises a G8 finish, i.e., a special filtration finish that increases filtration efficiency). As shown in TABLE 3 below, the applicant tested the filtration efficiency of three different filter media: (1) Sample 1 (labeled P-S1): 100% non-thermally splittable 3D fiber with a G8 finish; (2) Sample 2 (labeled P-S2) 70% non-thermally splittable 3D fiber with a G8 finish and 30% 5.6 D 60/40 splittable fiber; and (3) Sample 3 (labeled P-S3): 70% non-thermally splittable 3D fiber with a G8 finish with 30% 5.6 D 50/50 splittable fiber. Again, 60/40 and 50/50 correspond to volume ratio of first component and second component at the thermosplittable fiber. The first set of data indicates actual flat sheet results. The second set of data labeled with a * indicates flat sheet results normalized to 120 gsm.

TABLE 3

| | | | | | | | | | Predicted | | | | | Predicted |
|---|---|---|---|---|---|---|---|---|---|---|---|---|---|---|
| Names | | gsf | gsm | osy | PD | E1 | E2 | E3 | MERV | PD* | E1* | E2* | E3* | MERV* |
| Sample 1 | P-S1 | 11.4 | 123.0 | 3.6 | 0.2435 | 2.2 | 59.5 | 95.0 | 10 | 0.24 | 2.2 | 58.0 | 92.7 | 10 |
| Sample 2 | P-S2 | 11.7 | 126.4 | 3.7 | 0.2528 | 3.3 | 60.6 | 94.6 | 10 | 0.24 | 3.1 | 57.5 | 89.8 | 10 |
| Sample 3 | P-S3 | 10.73 | 115.4 | 3.4 | 0.2080 | 1.5 | 51.4 | 93.0 | 10 | 0.22 | 1.6 | 53.5 | 96.7 | 10 |

These results indicate that using a 50/50 splittable fiber (Sample 3) provided a lower PD (pressure drop) with similar efficiencies compared to the 60/40 splittable fiber blend and sample 1.

As shown in TABLE 4 below, the applicant conducted a second test of the filtration efficiency of five different filter media combinations. Note that G6 and G8 correspond to a standard spin finish (G6) and a spin finish that increases filtration efficiency (G8), respectively. (1) Sample 1 (labeled S1):100% non-thermally splittable 3D bicomponent fiber with a concentric core/sheath with G6 spin finish (thickness of 83 mil) (2) Sample 2 (labeled S2) 70% non-thermally splittable 3D bicomponent fiber with a concentric core/sheath with G6 spin finish and 30% 5.6 D 60/40 splittable fiber (thickness of 101 mil); and (3) Sample 3 (labeled S3): 70% non-thermally splittable 3D bicomponent fiber with a concentric core/sheath with G6 spin finish and 30% 5.6 D 50/50 splittable fiber (thickness of 75 mil). Sample 4 (labeled S4) was a 60% non-thermally splittable 3D bicomponent fiber with a concentric core/sheath with G6 finish and 40% 5.6 D 50/50 splittable fiber (thickness of 60 mil). Sample 5 (labeled S5) was a 60% non-thermally splittable 3D bicomponent fiber with an eccentric core/sheath and a 3D bicomponent green colored fiber with G8 finish.

TABLE 4

| | | | | | PD at | | | | Pre- |
|---|---|---|---|---|---|---|---|---|---|
| | | | | | 180 | | | | dicted |
| Names | | gsf | gsm | osy | fpm | E1 | E2 | E3 | MERV |
| Sample 1 | S1 | 7.83 | 84.24 | 2.49 | 0.14 | 2.4 | 37.4 | 65.1 | 7 |
| Sample 2 | S2 | 7.72 | 83.02 | 2.45 | 0.14 | 2.9 | 37.8 | 68.4 | 7 |
| Sample 3 | S3 | 7.68 | 82.68 | 2.44 | 0.15 | 3.2 | 39.7 | 73.8 | 8 |
| Sample 4 | S4 | 7.21 | 77.60 | 2.29 | 0.14 | 3.2 | 41.1 | 71.3 | 8 |
| Sample 5 | S5 | 5.95 | 63.99 | 1.89 | 0.10 | 0.2 | 31.6 | 75.1 | 8 |

As shown, the two samples with thermally splittable fibers (samples 2 and 3) had increased efficiencies in particularly at E3 with substantially the same pressure drop.

As shown, the eccentric core/sheath of sample 5 reduced the overall pressure drop of the filter media. In addition, the G8 spin finish substantially increased the efficiency of a filter media in capturing contaminants in the E3 particle group compared to other samples.

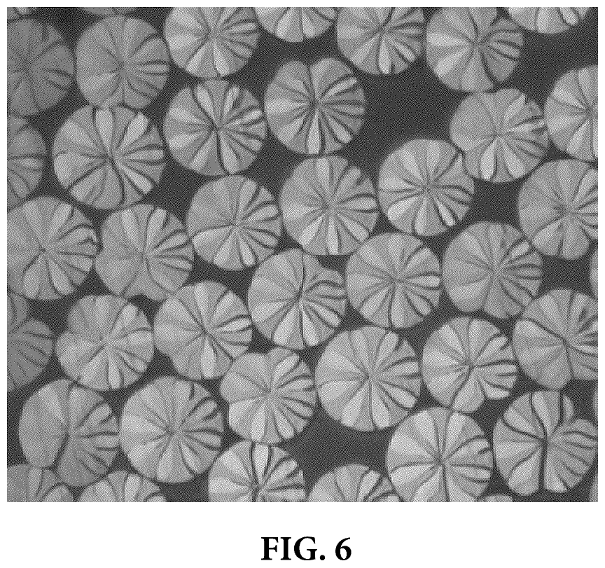

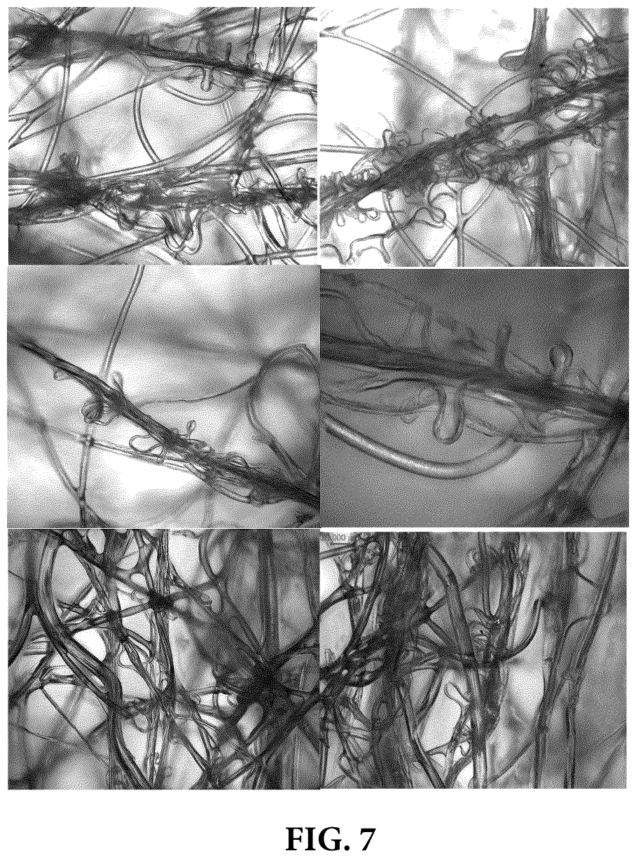

In a preferred embodiment, the applicant produced 16 segmented pie. 1^{st} component was PLA while second component was the blend of PP (85%) and Vistamaxx (15%). FIG. 6 is an optical microscope image of a cross-section of the fiber. FIG. 7 illustrates a series of optical images of the web surface after carding and bonding. Segmental curliness are due to splitting and shrinking. In an alternative embodiment, thermosplittable bicomponent fiber may be produced with bicomponent spunbonding technology, where the filaments are continuous.

In an alternative embodiment, the filter may also include nanoparticles incorporated into the substrate or filter media. As used herein, the term “nanoparticle” means any particle that has a dimension less than 1 micron in at least one axis or dimension. For example, a fiber having a diameter or width less than a micrometer and a length greater than 1 micrometer is a nanoparticle as used herein. The nanofibers may have a continuous length, or the nanofibers may have discrete length, such as 1 to 100,000 microns, preferably between about 100 to 10,000 microns.

In certain embodiments, the nanoparticles are dispersed “in depth” within the substrate. As used herein, the term “in depth” means that the nanoparticles are dispersed beyond a first surface of the substrate such that at least some of the nanoparticles are disposed between first and second opposing surfaces into the internal structure of the substrate or media. In certain embodiments, the nanoparticles are dispersed throughout substantially the entire media from the first surface to the opposing second surface. In other embodiments, the nanoparticles are dispersed through a portion of the media from the first surface to a location between the first and second surfaces.

The nanoparticles can be chosen with different triboelectric properties relative to the first or second fibers in order to use a triboelectric effect to enhance particle removal. With this method, the generated nanoparticles are formed in an electrical field and are less subject to contamination by chemicals that may moderate the triboelectric effect. Nanoparticles with different adsorption properties or surface charge characteristics than the coarse fibers can also be used, e.g. in oil or water filtration. This difference can be used to enhance or create localized electrical field gradients within the filter media to enhance particle removal. The nanoparticles and coarse fibers may have different wetting characteristics.

The nanoparticles may comprise any suitable material, such as glass, biosoluble glass, ceramic materials, acrylic, carbon, metal, such as alumina, polymers (such as nylon, polyethylene terephalate, and the like), polyvinyl chloride (PVC), polyolefin, polyacetal, polyester, cellulous ether, polyalkylene sulfide, poly (arylene oxide), polysulfone, modified polysulfone polymers and polyvinyl alcohol, polyamide, polystyrene, polyacrylonitrile, polyvinylidene chloride, polymethyl methacrylate, polyvinylidene fluoride and any combination thereof.

In some embodiments, the nanoparticles are bonded to the fibers via mechanical entanglement. This mechanical bond can be supplemented with an adhesive or binding agent. In certain embodiments, the nanoparticles are not crimped (i.e., they do not include significant wavy, bent, curled, coiled sawtooth or similar shape associated with the nanoparticle in a relaxed state. In other embodiments, the nanoparticles may have a crimped body structure with a discrete length. For instance, when these crimped nanofibers having a discrete length are attached to the fiber, they entangle among themselves and also with, onto, and around, the fiber with a firm attachment to form a modified fiber. In other embodiments, the attachment of the nanofibers to the micron fibers is accomplished via electrostatic charge attraction and/or Van der Waals force attraction between the fibers and the nanoparticles. A more complete description of filter media incorporating nanoparticles can be found in commonly assigned, co-pending U.S. provisional patent applications Ser. Nos. 63/328,970, 63/328,959, 63/328,983, 63/328,998, 63/329,009, 63/329,018, 63/329,137, 63/329,146, 63/329,155, 63/329,158, 63/329,161 and 63/329,162 all filed Apr. 8, 2022, the complete disclosure of which is incorporated herein by reference in its entirety for all purposes.

In other embodiments, an absorbent pad and bandage for application to a wound is provided that includes one or more of the bicomponent fibers described herein. These biocomponent fibers increase the surface area of the absorbent pad, thereby increasing its liquid absorbency.

The absorbent pad and bandage may be directed to treatment of any type of break or opening of epithelial tissue, such as skin. For example, a wound may be an abrasion, scraping, scab, blister, burn, incision, laceration, puncture, or an avulsion, and the absorbent material may be applied to the wound bed or the healing, closing tissue. The absorbent material of this disclosure may also be used on eschars, ulcers, and infected skin. Typical fluids which drain from a wound and enter the layer or layers of the absorbent pad include blood and its components therein, sweat, serous fluid, pus, and the like. The material may be used for wounds of any size, shape, or depth, and in a clinical setting or otherwise.

In one such embodiment, a bandage or wound dressing includes an adhesive layer and an absorbent pad. An additional layer, such as a backing layer, may also be a layer of the bandage. In certain embodiments, a wound-release layer may be added to the surface of the absorbent pad that makes contact with the wound. It is understood that other types of backing or release layers may be added, and may include layers associated with easy removal of the pad or bandage from its packaging. Alternatively, a release layer may be present on the surface of the adhesive layer such as, for example, silicone paper release strips (not shown), which the user may remove before placement of the bandage onto skin. A more complete description of a suitable bandages or wound dressings for use with the biocomponent fibers described herein can be found in commonly assigned, co-pending U.S. patent application Ser. No. 16/989,209, filed Feb. 21, 2021, the complete disclosures of which is incorporated herein by reference.

In one embodiment, the absorbent pad comprises a first polymer layer and a second layer thermally bonded to the first layer and comprising at least one thermally bondable fiber. In embodiments, the thermally bondable fiber comprises a biocomponent fiber as described above. The biocomponent fiber may comprise any suitable configuration, such as core/sheath with a concentric or eccentric core, side by side, segmented pie, island in the sea, hollow bicomponent fiber, hollow segmented pie, trilobal bicomponent fiber, mixed fibers, striped fibers, conductive fibers and the like. The bicomponent fiber may have a solid or a hollow core.

In embodiments, the bicomponent fiber comprises first and second components. The first component comprises a thermoplastic elastomer material and a thermoplastic material and has a higher shrinkage percentage ratio than the second component such that at least a portion of the first component separates from the second component upon the application of heat or thermal energy to the fiber. Suitable materials for the first and second components are described above. In embodiments, the thermoplastic elastomer material of the first component is less than about 25% by weight of the first component, or about 10% to about 20% by weight of the first component, preferably about 15%.

The ratio of weight between the first and second components may be about 20/80 to about 80/20. In certain embodiments, the second component has a greater weight percentage than the first component. In an exemplary embodiment, the first component has a weight percentage of about 50% of the bicomponent fiber, or about 40% or about 30% or about 20%.

The bicomponent fiber may comprise staple fibers or continuous fibers. The fibers may be naked (i.e., zero spin finish) prior to filter media making process. The fibers may include a spin finish prior to the filter media making process.

While the devices, systems and methods have been described in detail herein in accordance with certain preferred embodiments thereof, many modifications and changes therein may be effected by those skilled in the art. Accordingly, the foregoing description should not be construed to be limited thereby but should be construed to include such aforementioned obvious variations and be limited only by the spirit and scope of the following claims.

For example, in a first aspect, a first embodiment is a filter media comprising a bicomponent fiber comprising first and second components. The first component has a lower melting point than the second component. The first component comprises a thermoplastic elastomer material and a thermoplastic material. The thermoplastic elastomer material is less than about 25% by weight of the first component.

A second embodiment is the first embodiment, wherein the first component has a higher shrinkage ratio or percentage or rate than the second component.

A third embodiment is any combination of the first 2 embodiments, wherein the thermoplastic elastomer material is between about 10% to about 20% by weight of the first component.

A 4^{th} embodiment is any combination of the first 3 embodiments, wherein the thermoplastic elastomer material is about 15% by weight of the first component.

A 5^{th} embodiment is any combination of the first 4 embodiments, wherein the first component has substantially the same melt viscosity as the second component.

A 6^{th} embodiment is any combination of the first 5 embodiments, wherein the thermoplastic material of the first component comprises a material selected from the group consisting of polyolefins, polyethylene (PE), polypropylene (PP), blends of PP and PE, PBT, PET, CoPET, Nylon, PLA, and combinations thereof.

A 7^{th} embodiment is any combination of the first 6 embodiments, wherein the thermoplastic elastomer material comprises a material selected from the group consisting of a styrene block copolymer (SBS, SIS, SEBS), an olefin block polymer, a thermoplastic polyolefin elastomer (TPO), a thermoplastic polystyrene elastomer (TPS), a polyester copolymer elastomer, a thermoplastic vulcanizate (TPV), a polyamide elastomer (PEBAX), a thermoplastic polyurethane (TPU), an ionomer, an ethylene vinyl acetate (EVA), a propylene-based elastomer, a propylene-ethylene copolymer, an ethylene octane copolymer and combinations thereof.

An 8^{th} embodiment is any combination of the first 7 embodiments, wherein the bicomponent fiber comprises a segmented pie.

A 9^{th} embodiment is any combination of the first 8 embodiments, wherein the segmented pie is concentric.

A 10^{th} embodiment is any combination of the first 9 embodiments, wherein the segmented pie is eccentric.

An 11^{th} embodiment is any combination of the first 10 embodiments, wherein the biocomponent fiber has a hollow center portion.

A 12^{th} embodiment is any combination of the first 11 embodiments, wherein the hollow center is concentric.

A 13^{th} embodiment is any combination of the first 12 embodiments, wherein the hollow center is eccentric.

A 14^{th} embodiment is any combination of the first 13 embodiments, wherein the bicomponent fiber comprises discontinuous staple fibers.

A 15^{th} embodiment is any combination of the first 14 embodiments, wherein the bicomponent fiber is continuous.

A 16^{th} embodiment is any combination of the first 15 embodiments, wherein the first and second components are heated to a temperature of about 110 degrees C. to about 180 degrees C.

A 17^{th} embodiment is any combination of the first 16 embodiments, wherein the first and second components are heated to a temperature of about 130 degrees C. to about 150 degrees C.

An 18^{th} embodiment is any combination of the first 17 embodiments, wherein the bicomponent fiber has a linear mass density of about 2 denier to about 16 denier.

A 19^{th} embodiment is any combination of the first 18 embodiments, wherein the first component is about 40% to about 60% by weight of the first and second components.

A 20^{th} embodiment is any combination of the first 19 embodiments, wherein the first component is about 50% by weight of the first and second components.

A 21^{st} embodiment is any combination of the first 20 embodiments, wherein the second component is a polymer comprising a material selected from the group consisting of polyolefins, polyethylene (PE), polypropylene (PP), blends of PP and PE, PBT, PET, PLA, Nylon, PHB, PTFE, and combinations thereof.

A 22^{nd} embodiment is any combination of the first 21 embodiments, further comprising a second bicomponent fiber comprising first and second components having substantially different melting points and lower melting portion acts as binder fiber.

A 23^{rd} embodiment is any combination of the first 22 embodiments, wherein the second bicomponent fiber comprises about 30% to about 70% by weight of the filter media.

A 24^{th} embodiment is any combination of the first 23 embodiments, wherein the second biocomponent fiber comprises a core and a sheath.

A 25^{th} embodiment is any combination of the first 24 embodiments, wherein the core is eccentric with the sheath.

In another aspect, an air filter product is provided comprising the filter media of any combination of the first 25 embodiments.

In another aspect, a first embodiment is a filter media comprising a bicomponent fiber comprising a first component and a second component. At least a portion of the first component separates from the second component when heated to a threshold temperature. The first component comprises a thermoplastic elastomer material and a thermoplastic material. The thermoplastic elastomer material is less than about 25% by weight of the first component.

A second embodiment is the first embodiment, wherein the threshold temperature is about 110 degrees C. to about 180 degrees C.

A third embodiment is any combination of the first 2 embodiments, wherein the threshold temperature is about 130 degrees C. to about 150 degrees C.

A 4^{th} embodiment is any combination of the first 3 embodiments, wherein the first component has a lower melting point.

A 5^{th} embodiment is any combination of the first 4 embodiments, wherein the first component has a higher shrinkage ratio/percentage than the second component.

A 6^{th} embodiment is any combination of the first 5 embodiments, wherein the first component has substantially the same melt viscosity as the second component.

A 7^{th} embodiment is any combination of the first 6 embodiments, further comprising a second biocomponent fiber having a first component and a second component, wherein the first component remains substantially bonded to the second component when heated to the threshold temperature.

An 8^{th} embodiment is any combination of the first 7 embodiments, wherein the second bicomponent fiber comprises about 30% to about 70% by weight of the filter media.

A 9^{th} embodiment is any combination of the first 8 embodiments, wherein the thermoplastic elastomer material is between about 10% to about 20% by weight of the first component.

A 10^{th} embodiment is any combination of the first 9 embodiments, wherein the thermoplastic elastomer material is 15% by weight of the first component.

In another aspect, an air filter product is provided comprising the filter media of any combination of the first 10 embodiments.

In another aspect, a first embodiment is a method of making a filter media comprising providing a bicomponent fiber having first and second components and heating the biocomponent fiber such that at least a portion of the first component separates from the second component. The first component comprises a thermoplastic elastomer material and a thermoplastic material. The thermoplastic elastomer material is less than about 25% by weight of the first component.

A second embodiment is the first embodiment, further comprising extruding the first and second components together to form the bicomponent fiber.

A third embodiment is any combination of the first two embodiments, wherein the first and second components are extruded to form a segmented pie bicomponent fiber.

A 4^{th} embodiment is any combination of the first 3 embodiments, wherein the biocomponent fiber is heated to a temperature of about 110 degrees C. to about 180 degrees C.

A 5^{th} embodiment is any combination of the first 4 embodiments, wherein the biocomponent fiber is heated to a temperature of about 130 degrees C. to about 150 degrees C.

A 6^{th} embodiment is any combination of the first 5 embodiments, further comprising crimping the bicomponent fiber.

A 7^{th} embodiment is any combination of the first 6 embodiments, wherein a crimp count of the biocomponent fiber is about 8 to about 20 crimps/inch.

An 8^{th} embodiment is any combination of the first 7 embodiments, further comprising applying a coating to the bicomponent fiber to spin finish the fiber.

A 9^{th} embodiment is any combination of the first 8 embodiments, further comprising shrinking the first component by at least about 10% during the heating.

A 10^{th} embodiment is any combination of the first 9 embodiments, further comprising shrinking the first component by at least about 30% during the heating.

An 11^{th} embodiment is any combination of the first 10 embodiments, further comprising carding the bicomponent fiber.

A 12^{th} embodiment is any combination of the first 11 embodiments, further comprising forming the biocomponent fiber with a process selected from the group consisting of spunbond and meltblown.

A 13^{th} embodiment is any combination of the first 12 embodiments, further comprising blending a second bicomponent fiber with the first bicomponent fiber, the second bicomponent fiber having first and second components that remain substantially bonded to each other during heating.

A 14^{th} embodiment is any combination of the first 13 embodiments, wherein the second bicomponent fiber comprises about 30% to about 70% by weight of the filter media.

In another aspect, an air filter is provided that is manufactured from the process of any combination of the above 14 embodiments.

In another aspect, a first embodiment is a bicomponent fiber comprises first and second components. The first component has a lower melting point than the second component and comprises a thermoplastic elastomer material and a thermoplastic material. The thermoplastic elastomer material is less than about 25% by weight of the first component.

A second embodiment is the first embodiment, wherein the first component has a higher shrinkage ratio/percentage/rate than the second component.

A third embodiment is any combination of the first two embodiments, wherein the thermoplastic elastomer material is about 15% by weight of the first component.

A 4^{th} embodiment is any combination of the first 3 embodiments, wherein the thermoplastic material of the first component comprises a material selected from the group consisting of polyolefins, polyethylene (PE), polypropylene (PP), blends of PP and PE, PBT, PET, CoPET, Nylon, PLA, and combinations thereof.

A 5^{th} embodiment is any combination of the first 4 embodiments, wherein the thermoplastic elastomer material comprises a material selected from the group consisting of a styrene block copolymer (SBS, SIS, SEBS), an olefin block polymer, a thermoplastic polyolefin elastomer (TPO), a thermoplastic polystyrene elastomer (TPS), a polyester copolymer, a thermoplastic vulcanizate (TPV), a polyamide elastomer (PEBAX), a thermoplastic polyurethane (TPU), an ionomer, an ethylene vinyl acetate (EVA), a propylene-based elastomer, a propylene-ethylene copolymer, an ethylene octane copolymer and combinations thereof.

A 6^{th} embodiment is any combination of the first 5 embodiments, wherein the bicomponent fiber comprises a segmented pie.

A 7^{th} embodiment is any combination of the first 6 embodiments, wherein the first component is about 40% to about 60% by weight of the first and second components.

An 8^{th} embodiment is any combination of the first 7 embodiment, wherein the second component is a polymer comprising a material selected from the group consisting of polyolefins, polyethylene (PE), polypropylene (PP), blends of PP and PE, PBT, PET, PLA, Nylon, PHB, PTFE, and combinations thereof.

In another aspect, an absorbent pad for a wound dressing is provided comprising the bicomponent fiber of any combination of the above 8 embodiments.

In another aspect, a wound dressing is provided comprising the bicomponent fiber of any combination of the above 8 embodiments.

What is claimed is:

1. A filter media comprising:
a bicomponent fiber comprising first and second components, wherein the first component has a lower melting point than the second component; and
wherein the first component comprises a thermoplastic elastomer material and a thermoplastic material, wherein the thermoplastic elastomer material is less than about 25% by weight of the first component.

2. The filter media of claim 1, wherein the thermoplastic elastomer material is between about 10% to about 20% by weight of the first component.

3. The filter media of claim 1, wherein the thermoplastic elastomer material is about 15% by weight of the first component.

4. The filter media of claim 1, wherein the thermoplastic material of the first component comprises a material selected from the group consisting of polyolefins, polyethylene (PE), polypropylene (PP), blends of PP and PE, PBT, PET, CoPET, Nylon, PLA, and combinations thereof.

5. The filter media of claim 1, wherein the thermoplastic elastomer material comprises a material selected from the group consisting of a styrene block copolymer (SBS, SIS, SEBS), an olefin block polymer, a thermoplastic polyolefin elastomer (TPO), a thermoplastic polystyrene elastomer (TPS), a polyester copolymer elastomer, a thermoplastic vulcanizate (TPV), a polyamide elastomer (PEBAX), a thermoplastic polyurethane (TPU), an ionomer, an ethylene vinyl acetate (EVA), a propylene-based elastomer, a propylene-ethylene copolymer, an ethylene octane copolymer and combinations thereof.

6. The filter media of claim 1, wherein the bicomponent fiber comprises a segmented pie.

7. The filter media in claim 8, wherein the segmented pie is concentric.

8. The filter media in claim 8, wherein the segmented pie is eccentric.

9. The filter media of claim 9, wherein the biocomponent fiber has a hollow center portion.

10. The filter media of claim 9, where in the hollow center is concentric.

11. The filter media of claim 9, wherein the hollow center is eccentric.

12. The filter media of claim 1, wherein the first and second components are heated to a temperature of about 110 degrees C. to about 180 degrees C.

13. The filter media of claim 1, wherein the first and second components are heated to a temperature of about 130 degrees C. to about 150 degrees C.

14. The filter media of claim 1, wherein the first component is about 40% to about 60% by weight of the first and second components.

15. The filter media of claim 1, wherein the first component is about 50% by weight of the first and second components.

16. The filter media of claim 1, wherein the second component is a polymer comprising a material selected from the group consisting of polyolefins, polyethylene (PE), polypropylene (PP), blends of PP and PE, PBT, PET, PLA, Nylon, PHB, PTFE, and combinations thereof.

17. The filter media of claim 1, further comprising a second bicomponent fiber comprising first and second components having substantially different melting points and lower melting portion acts as binder fiber.

18. The filter media of claim 17, wherein the second bicomponent fiber comprises about 30% to about 70% by weight of the filter media.

19. A filter media comprising:
a bicomponent fiber comprising a first component and a second component, wherein at least a portion of the first component separates from the second component when heated to a threshold temperature; and
wherein the first component comprises a thermoplastic elastomer material and a thermoplastic material, wherein the thermoplastic elastomer material is less than about 25% by weight of the first component.

20. The filter media of claim 19, wherein the threshold temperature is about 110 degrees C. to about 180 degrees C.

21. The filter media of claim 19, wherein the threshold temperature is about 130 degrees C. to about 150 degrees C.

22. The filter media of claim 19, wherein the first component has a lower melting point than the second component.

23. The filter media of claim 19, further comprising a second biocomponent fiber having a first component and a second component, wherein the first component remains substantially bonded to the second component when heated to the threshold temperature.

24. The filter media of claim 19, wherein the second bicomponent fiber comprises about 30% to about 70% by weight of the filter media.

25. The filter media of claim 19, wherein the thermoplastic elastomer material is between about 10% to about 20% by weight of the first component.
